(19) United States
(12) Patent Application Publication
(10) Pub. No.: US 2010/0149084 A1
(43) Pub. Date: Jun. 17, 2010

(54) Backlight Device and Image Display Device Provided Therewith

(75) Inventor: Taisuke Chida, Kyoto (JP)

Correspondence Address: FISH & RICHARDSON P.C., P.O. BOX 1022, MINNEAPOLIS, MN, 55440-1022, US

(73) Assignee: Rohm Co. Ltd, Kyoto (JP)

(21) Appl. No.: 12/088,490

(22) PCT Filed: Oct. 18, 2006
(86) PCT No.: PCT/JP2006/320739

§ 371 Date: Mar. 28, 2008

(30) Foreign Application Priority Data
Oct. 24, 2005 (JP) 2005 307944

(51) Int. Cl. G09G 3/36

(52) U.S. Cl. 345/102

(57) ABSTRACT

The backlight device of the present invention is provided with a light emitting unit emitting light of N (N≧2) colors and a light emission control unit making the light emitting unit emit light of one of the N colors for each field. The light emission control unit varying, from one flame to the next, the order of light emission colors within each frame is designed for use in the backlight device and an image display device incorporating such a backlight device. Thus, it is possible to realize the backlight device and the image display device incorporating such a backlight device in which, irrespective of an image recognition period (a period in which an image is recognized during the movement of the viewpoint on a display), the continuous recognition of light of the same color is prevented during the movement of the viewpoint on a display.

### TECHNICAL FIELD

The present invention relates to a backlight device for use in an image disp lay device employing a field sequential method, and to an image display device incorporating such a backlight device.

### BACKGROUND ART

Today, image display devices employing a field sequential method (hereinafter also called “FS method”) are being developed. The FS method uses, as a backlight for a display panel, a backlight unit incorporating, as a light source, LEDs (light-emitting diodes) of different colors, for example, RGB (red, green, and blue), and achieves image display by lighting those LEDs in turn on a time-division basis. Since this method requires no color filter, it offers advantages such as reduced production cost and satisfactory brightness. In the present specification, the time intervals at which the above-mentioned time division is executed are referred to as “fields”.

On the other hand, however, since image display devices employing the FS method have their uniqueness described above, new difficulties arise as to the color of emitted light. For example, patent document 1 mentions the disadvantage of unexpected colors appearing at the edge of a video pattern as the video image moves, and presents means for solving this problem.

As for the order in which the LEDs of different colors are lit, in conventional image display devices employing the FS method, they are lit in the same order in each frame, like “ . . . /RGB/RGB/RGB/ . . . ”.

Patent document 1: JP-A-2005-233982

### DISCLOSURE OF THE INVENTION

### Problems to be Solved by the Invention

Now, how a user moves his viewpoint while viewing an image on a display will be examined. As an example, consider a case where, as shown in FIG. 5, the user is about to move his viewpoint from point A to point B on a display. As the viewpoint so moves, it substantially traces line AB, for example, by moving from point A to point P1 to point P2 and so on, and meanwhile the user recognizes image information. Here, how often the user recognizes image information depends on the visual ability of that particular user, meaning that the recognition of image information usually takes place at fixed periods reflecting the user's visual ability, which varies from one user to another.

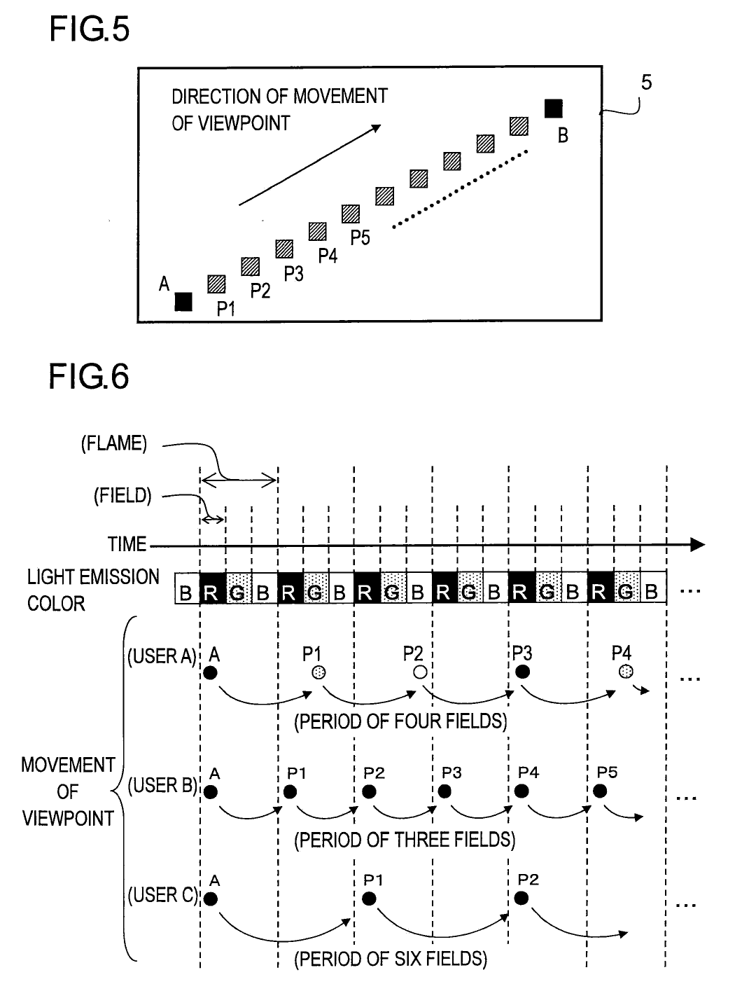

In a case where, as described above, image information is recognized every fixed period (hereinafter, referred to as “image recognition period”), the relationship between the movement of the viewpoint and the color in which a backlight is lit is as shown in FIG. 6. Here, as an example, assume that users A, B and C have image recognition periods corresponding to four fields, three fields and six fields, respectively.

First, with respect to user A, when the viewpoint is located at P1, the light emitted by the backlight is green G. Subsequently, as the viewpoint moves from P2 to P3 and to P4, the color of emitted light accordingly changes from blue B to red R and to green G. Thus, user A recognizes a plurality of different colors one after another in a short while, and therefore feels no particular uncomfortableness.

With respect to user B, however, when the viewpoint is located at P1, the light emitted by the backlight is red R. Subsequently, as the viewpoint moves from P2 to P3 and so on, the color of emitted light happens to be red R at all points. Thus, during the movement of the viewpoint, user B recognizes almost nothing but red light. Such continuous recognition of the same color causes exaggerated recognition of that color by the human eye. This inconveniently produces visual uncomfortableness. In some cases, an illusion is perceived that consists of a pattern of stripes of the different colors in which the light is emitted.

As is clear from FIG. 6, user C also suffers from the inconvenience described above. In image display devices employing the FS method where light of different colors is emitted in the same order in each frame as practiced conventionally, if the image recognition period is an integral multiple of the period of the frame, the above-discussed inconvenience arises.

An object of the present invention is to provide a backlight device with which it is possible to prevent continuous recognition of light of the same color alone during the movement of the viewpoint on a display irrespective of the image recognition period, and to provide an image display device incorporating such a backlight device.

### Means for Solving the Problem

To achieve the above object, according to one aspect of the present invention, a backlight device for use in an image display device employing a field sequential method includes: a light emitting unit emitting light of N (N≧2) colors; and a light emission control unit making the light emitting unit emit light of one of the N colors for each field. Here, the light emission control unit varies, randomly form one field to the next, the order of colors in which light is emitted within a frame (first configuration).

With this configuration, the order of light emission colors is varied randomly for each frame. Thus, the application of the backlight device of this configuration to an image display device employing the FS method makes less likely continuous recognition of the same color during the movement of the viewpoint on a display irrespective of the image recognition period, and accordingly makes less likely such inconveniences as exaggerated recognition of that color and the resulting uncomfortableness. “A frame” is referred to as “a period of time” that is assigned to display one image, and is composed of a plurality of fields.

In the first configuration described above, in each frame, the light emission control unit may emit light of each of the N colors for the same number of fields (second configuration). With this configuration, in each frame, the light emitting unit emits light of the N colors in equal proportions. Hence, light of a particular color is prevented from being only emitted with high frequency, and the appropriate image display is not prevented.

In the second configuration described above, the light emission control unit may make a color of light emitted at the last field in one frame different from a color of light emitted at the first field in the succeeding frame (third configuration).

With this configuration, light of the same color is prevented from being continuously emitted for two consecutive fields, like “B/B” in “ . . . /RGB/BGR/ . . . ”. Thus, it is possible to display more natural images than in the case where light of the same color may be continuously emitted for two consecutive fields.

In the first configuration described above, the backlight device may further include a random number generator generating a random number for each frame so that the light emission control unit determines the order of colors in which light is emitted in a frame according to the random number for the frame (fourth configuration).

With this configuration, the order of light emission colors for each frame is determined according to a random number generated by a predetermined random number generator. Hence, for example, with a general-purpose random number generator, it is possible to randomly vary the order of light emission colors for each frame with ease.

According to another aspect of the invention, a backlight device for use in an image display device employing a field sequential method includes: a light emitting unit emitting light of N (N≧2) colors; and a light emission control unit making the light emitting unit emit light of one of the N colors for each field. Here, the light emission control unit varies a length of the field randomly form one field to the next (fifth configuration).

With this configuration, the length of each field is varied randomly, that is, the length of the period during which light of each color is emitted is varied randomly. Thus, by applying the backlight device of this configuration to an image display device employing the FS method, it is possible to break the periodicity of the intervals at which light of the same color is emitted. This makes less likely continuous recognition of the same color during the movement of the viewpoint on a display irrespective of the image recognition period, and accordingly makes less likely such inconveniences as exaggerated recognition of that color and the resulting uncomfortableness. With this configuration, it is possible to break the periodicity of the intervals at which light of the same color is emitted even if the same order of light emission colors is repeated.

With an image display device employing the field sequential method and incorporating any one of the backlight devices of the first to fifth configurations described above, it is possible to realize an image display device employing the FS method that makes less likely such inconveniences as visual uncomfortableness.

### Advantages of the Invention

As described above, with a backlight device of the present invention, the order of light emission colors is varied randomly for each frame. Thus, by applying the backlight device of this configuration to an image display device employing the FS method, it is possible to make less likely continuous recognition of the same color during the movement of the viewpoint on a display irrespective of the image recognition period, and accordingly make less likely such inconveniences as exaggerated recognition of that color and the resulting uncomfortableness.

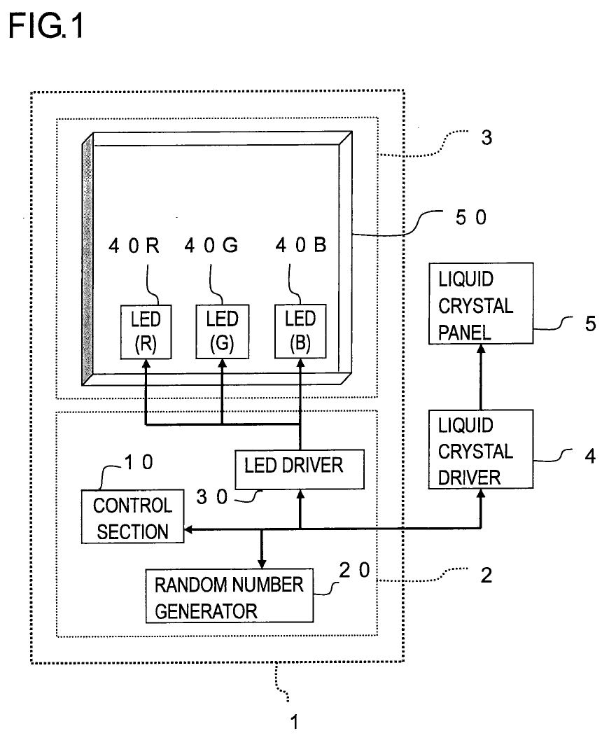

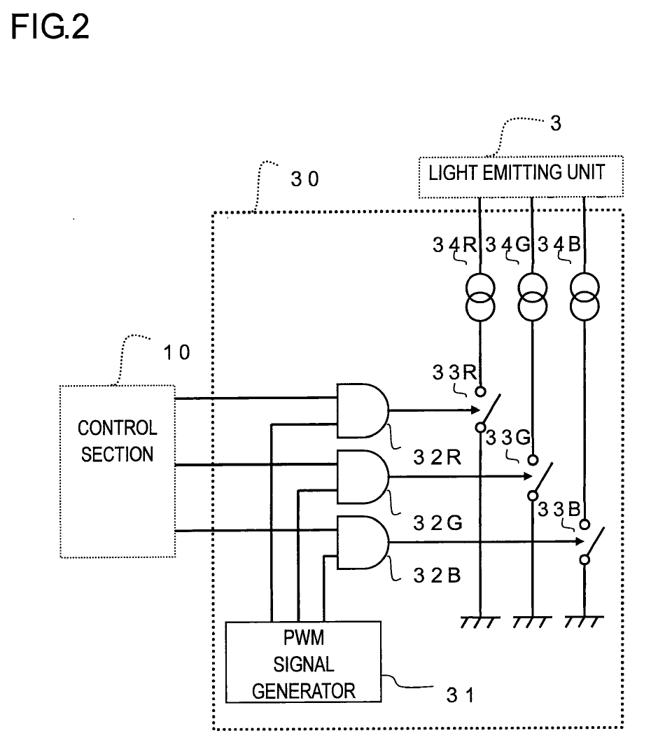

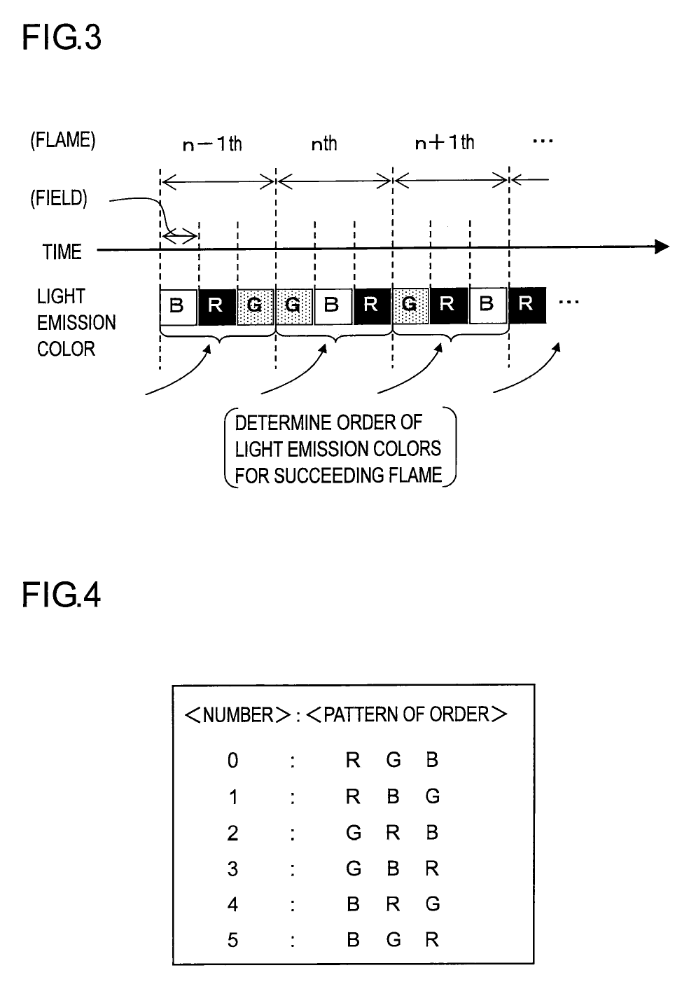

### BRIEF DESCRIPTION OF DRAWINGS

[FIG. 1] A diagram showing the overall configuration of a liquid crystal display device as an embodiment of the present invention;

[FIG. 2] A diagram showing the configuration of an LED driver in the embodiment of the invention;

[FIG. 3] A diagram illustrating the processing performed by a light emission control unit in the embodiment of the invention;

[FIG. 4] A diagram illustrating information on the order of the colors in which to emit light in the embodiment of the invention;

[FIG. 5] A diagram illustrating the movement of the viewpoint on a display; and

[FIG. 6] A diagram illustrating the relationship of different image recognition periods with the colors in which light is emitted.

### LIST OF REFERENCE SYMBOLS

1 Backlight device

2 Light emission control unit

3 Light emitting unit

4 Liquid crystal driver

5 Liquid crystal panel

10 Control section

20 Random number generator

30 LED driver

31 PWM signal generator

32R, 32G and 32B AND gate

33R, 33G and 33B Switch

34R, 34G and 34B Constant current source

40R, 40G and 40B LED

50 Light guide plate

### BEST MODE FOR CARRYING OUT THE INVENTION

Hereinafter, as an embodiment of the present invention, a description will be given of a liquid crystal display device employing an FS method. FIG. 1 is a diagram showing the overall configuration of the liquid crystal display device according to this embodiment. As shown in FIG. 1, this liquid crystal display device is composed of a backlight device 1, a liquid crystal driver 4, a liquid crystal panel 5 and other components.

The configuration of the backlight device 1 will now be described in detail. The backlight device 1 is broadly divided into two units: a light emission control unit 2 that is composed of a control section 10, a random number generator 20, an LED driver 30 and other components to allow a light emitting unit 3 to emit light of any one color of RGB; and the light emitting unit 3 that is composed of LEDs 40R, 40G and 40B, a light guide plate 50 and other components to emit light of any one color of RGB.

The control section 10 includes: a ROM in which control programs for different components, information on the order of the colors in which to emit light and the like are stored; a register; an arithmetic unit; and other components. The control section 10 controls the overall operation of the liquid crystal display device, and also feeds light emission pattern signals to both the LED driver 30 and the liquid crystal driver 4. The light emission pattern signals serve to transmit, as will be described later, information on a light emission pattern (such as the order of the colors in which to emit light).

The random number generator 20 is a general-purpose random number generator or the like that generates a random number for each frame. In this embodiment, as a random number, any one of six integers from zero to five is generated with substantially equal probability. As will also be described later, the random numbers thus generated are used in order to break the frame-to-frame periodicity of the order of light emission colors and thus to prevent continuous recognition of the same color. Accordingly, the random numbers generated by the random number generator 20 do not necessarily need to be completely random. As long as the above-mentioned purpose is achieved, a certain degree of periodicity is permissible. This allows the use of any random number generator.

The LED driver 30 receives the light emission pattern signals from the control section 10, and supplies electric power to the LEDs 40R, 40G and 40B according to the signals received. As shown in FIG. 2, the LED driver 30 is composed of a PWM signal generator 31, AND gates 32R, 32 G and 32B, switches 33R, 33G and 33B, constant current sources 34R, 34G and 34B and other components. A letter R, G or B suffixed to a reference numeral indicates the color (red, green or blue) concerned. The LEDs 40R, 40G and 40B may each consist of a single LED or a plurality of LEDs.

The PWM signal generator 31 generates PWM signals to control the amount of currents supplied to the LEDs 40R, 40G and 40B by PWM (pulse width modulation). Specifically, the PWM signal generator 31 controls the width of high-level pulses in the PWM signals, and thereby adjusts the duty ratio of the corresponding currents through the opening and closing (which will be described later) of the switches 33R, 33G and 33B.

The AND gates 32R, 32G and 32B receive the light emission pattern signals from the control section 10 and the PWM signals from the PWM signal generator 31, and feed the results of their AND operation to the switches 33R, 33G and 33B, respectively.

When the switches 33R, 33G and 33B receive high-level signals from the AND gates 32R, 32G and 32B respectively, they close; when the switches 33R, 33G and 33B receive low-level signals, they open. Only when the switches 33R, 33G and 33B are closed, the constant current sources 34R, 34G and 34B supply currents to the LEDs 40R, 40G and 40B, respectively.

With the configuration described above, the light emission control unit 2 supplies a predetermined amount of electric power to the LEDs 40R, 40G and 40B. When the LEDs 40R, 40G and 40B receive the electric power, they emit light that is guided to the back of the liquid crystal panel 5 through the light guide plate 50.

The liquid crystal driver 4 receives the light emission pattern signal described previously and an image signal to drive the liquid crystal panel. The liquid crystal panel 5 is composed of: two substrates that are disposed opposite each other with a liquid crystal layer interposed therebetween; electrodes that are provided, one for each pixel, on the substrate; TFTs (thin film transistor) serving as switching elements; and other components. With this configuration, by applying voltages between pixel electrodes to control the optical rotatory power of the liquid crystal, it is possible to adjust the transmittance of the light from the backlight, and thereby display the desired image.

A description will now be given of the flow of the processing performed by the light emission control unit 2 with reference to FIG. 3. With respect to the order of the colors in which to emit light, at each frame, the order for the succeeding frame is determined. Specifically, the random number generator 20 generates a random number for the succeeding frame. The control section 10 reads the information of this random number, and writes in the register the information on the order of light emission colors corresponding to the random number as the control information for the succeeding frame. The information on the order of light emission colors is stored in the ROM included in the control section, one set of such information for each of different random numbers.

With respect to the light emission processing, according to the information on the order of light emission colors (written in the register) as determined at the preceding frame, the control section 10 outputs the light emission pattern signals to the LED driver 30. The LED driver 30 receives the light emission pattern signals, and, for each field, supplies electric power to one of the LEDs 40R, 40G and 40B at a time to allow the emitting unit to emit light of the corresponding color.

Here, by way of an example, a description will be given of a case where the information on the order of light emission colors is set as shown in FIG. 4, and a “3” is generated as the random number for the nth frame. In this case, the control section 10 writes in the register the information on the order of light emission colors corresponding to the number “3”, that is, the order “GBR” (which means that light is emitted in the order of G, B and R).

When the nth frame begins, at the first field in the nth frame, the control section 10 outputs, based on the information stored in the register, a high-level signal to the AND gate 32G and low-level signals to the other AND gates. Consequently, the switch 33G alone opens and closes according to the corresponding PWM signal, and thus the LED 40G alone emits green light. Then, in the same manner as described above, at the second field, the LED 40R alone emits red light; at the third field, the LED 40B alone emits blue light.

Meanwhile, the control section 10 outputs an image display signal to the liquid crystal driver 4. The image display signal is coordinated with the light emission pattern signals; while the light emission pattern signal for a given color is outputted, the image display signal designates the pixels where that color should be displayed. The liquid crystal driver 4 receives this image display signal, and drives the liquid crystal panel 5 to display a predetermined image.

With the above-described configuration of this liquid crystal display device, the order of the colors in which light is emitted is varied randomly for each frame. This makes less likely the continuous recognition of the same color during the movement of the viewpoint on a display irrespective of the image recognition period, and accordingly makes less likely such inconveniences as exaggerated recognition of a given color and the resulting uncomfortableness.

Even though the order of light emission colors is random for each frame, within each frame, light of each color of RGB is emitted for the same number of fields (one field in this embodiment). In other words, in any frame, the light emitting unit emits light of RGB in equal proportions. Thus, it does not occur that light of a given color is emitted more often, which causes improper image display.

The proportion of the colors may be varied randomly, as long as the proportion of the colors is held substantially constant within a predetermined period. For example, varying the length of fields randomly also helps break the periodicity of the intervals at which light of a given color is emitted. This makes less likely the continuous recognition of the same color during the movement of the viewpoint on a display irrespective of the image recognition period. Just as the order of light emission colors is varied randomly in the manner described above, the length of fields can be varied randomly as by use of a random number generator before the succeeding field begins.

As shown in FIG. 3, for example, both at the third field in the (n−1)th frame and at the first field in the nth frame, the color of the emitted light is green (G), that is, light of the same color is continuously emitted for two consecutive fields. In order that such consecutive emission of light of the same color may be prevented, the color of the light emitted at the last field in one frame may be controlled to differ from the color of the light emitted at the first field in the succeeding frame.

Specifically, for example, in a case where the order of light emission colors is “GBR”, the order in n+1th frame is set so that it is neither “RGB” nor “RBG”. In a case where the information is set as shown in FIG. 4, this control is achieved by avoiding numbers “0” and “1”, that is, by randomly selecting one of numbers from 2 to 5. In this way, it is possible to display more natural images than in the case where light of the same color may be consecutively emitted.

Although the above description discusses one embodiment of the present invention, the invention is not limited to such an embodiment. Many variations and amendments are possible without departing from the sprit of the invention.

### INDUSTRIAL APPLICABILITY

The technology of the invention is useful for image display devices adopting the field sequential method.

1. A backlight device for use in an image display device employing a field sequential method, the backlight device comprising:
a light emitting unit to emit light of N colors, where N≧2; and
a light emission control unit to cause the light emitting unit to emit light of one of the N colors for each field,
wherein the light emission control unit is configured to vary, randomly form one field to a next, the order of colors in which light is emitted within a frame.

2. The backlight device of claim 1, wherein, the light emission control unit is configured to cause emission, in each frame, of light of each of the N colors for a same number of fields.

3. The backlight device of claim 2, wherein the light emission control unit is configured to cause a color of light emitted at a last field in one frame different from a color of light emitted at a first field in a succeeding frame.

4. The backlight device of claim 1, further comprising:
a random number generator to generate a random number for each frame,
wherein the light emission control unit is configured to determine the order of colors in which light is emitted within a frame according to the random number for the frame.

5. A backlight device for use in an image display device employing a field sequential method, the backlight device comprising:
a light emitting unit to emit light of N colors, where N≧2; and
a light emission control unit to cause the light emitting unit to emit light of one of the N colors for each field,
wherein the light emission control unit is configured to vary a length of the field randomly form one field to a next.

6. An image display device employing a field sequential method, the image display device comprising the backlight devices of any one of claims 1 to 5.
